(19) United States
(12) Patent Application Publication
(10) Pub. No.: US 2008/0087089 A1
(43) Pub. Date: Apr. 17, 2008

(54) APPARATUS AND METHOD FOR FORMING AN ULTRASOUND IMAGE

(75) Inventor: Sang Gyu Nam, Seoul (KR)

Correspondence Address: OBLON, SPIVAK, MCCLELLAND MAIER & NEUSTADT, P.C., 1940 DUKE STREET, ALEXANDRIA, VA, 22314, US

(73) Assignee: Medison Co., Ltd., Hongchun-gun (KR)

(21) Appl. No.: 11/868,120

(22) Filed: Oct. 5, 2007

(30) Foreign Application Priority Data
Oct. 17, 2006 (KR) 10-2006-0100903

(51) Int. Cl. G01N 29/00

(52) U.S. Cl. 73/596

(57) ABSTRACT

The present invention is directed to an ultrasound system and method for forming an ultrasound image. A plurality of scan line groups each having the respective scan line density are set based on a predetermined reference scan line group. The predetermined reference scan line group includes a plurality of scan lines each having a predetermined reference scan line density. The ultrasound signals are received and transmitted along the scan lines of the respective scan line groups to form the frame data. The frames corresponding to the respective scan line groups are formed based on the frame data. The frames are then spatially compounded to form a compound image.

The present application claims priority from Korean Patent Application No. 10-2006-100903 filed on Oct. 17, 2006, the entire subject matter of which is incorporated herein by reference.

### BACKGROUND

1. Field

The present invention generally relates to an ultrasound system, and more particularly to an ultrasound system for forming an ultrasound image.

2. Background

An ultrasound system has become an important and popular diagnostic tool since it has a wide range of applications. Specifically, due to its non-invasive and non-destructive nature, the ultrasound system has been extensively used in the medical profession. Modern high-performance ultrasound systems and techniques are commonly used to produce two or three-dimensional diagnostic images of internal features of an object (e.g., human organs).

Generally, in order to transmit and receive wideband ultrasound signals, the ultrasonic system comprises a plurality of transducers. When electrically stimulating a transducer, an ultrasound signal is generated and then transmitted to an object. The ultrasound echo signals reflected from the object and transmitted to the transducer are electrically converted. The converted electrical signals are amplified and signal-processed to produce image data.

The ultrasound system needs to increase the density of scan lines (i.e., number of scan lines) in forming one frame to improve the resolution of an ultrasound image. However, there is a drawback in that the frame-rate is lowered as the density of scan lines increases. Therefore, there is a need for an ultrasound system, which is capable of improving the resolution of an ultrasound image without lowering the frame-rate.

### BRIEF DESCRIPTION OF THE DRAWINGS

Arrangements and embodiments may be described in detail with reference to the following drawings in which like reference numerals refer to like elements and wherein:

FIG. 1 is a block diagram illustrating one embodiment of the present invention;

FIGS. 2 to 4 are exemplary diagrams showing a group of scan lines and a frame in accordance with embodiments of the present invention;

FIG. 5 is an exemplary diagram showing a spatial compound of the respective groups of scan lines in accordance with one embodiment of the present invention.

### DETAILED DESCRIPTION OF THE PRESENT INVENTION

A detailed description may be provided with reference to the accompanying drawings. One of ordinary skill in the art may realize that the following description is illustrative only and is not in any way limiting. Other embodiments of the present invention may readily suggest themselves to such skilled persons having the benefit of this disclosure.

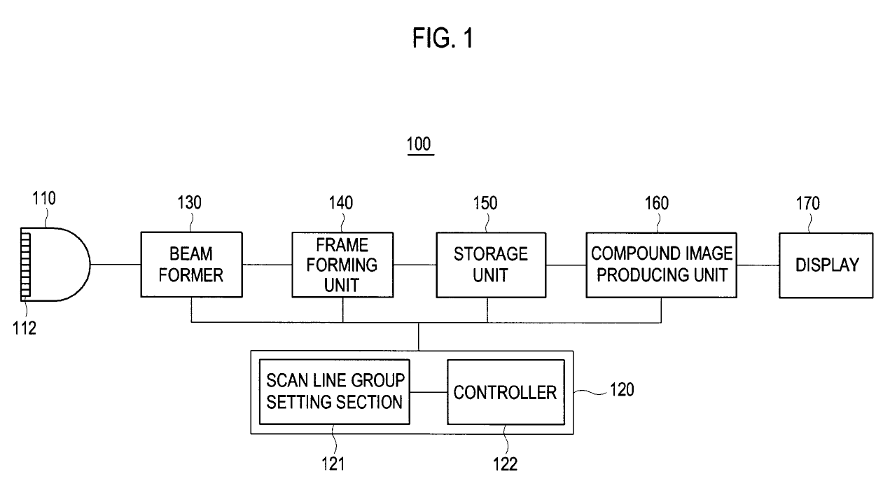

FIG. 1 is a block diagram showing one embodiment of the present invention. As shown in FIG. 1, the ultrasound system 100 includes a probe 110, a scan line setting unit 120, a beam former 130, a frame forming unit 140, a storage unit 150, a compound image producing unit 160 and a display 170. The frame forming unit 140 and the compound image producing unit 160 can be embodied as one processor. The probe 110 includes an array transducer 112 including a plurality of transducers. The probe 110 transmits and receives ultrasonic signals along the scan lines, which change at every frame change so as to form a plurality of frames for spatial compound.

The scan line setting unit 120 includes a scan line group setting section 121 and a controller 122. The scan line group setting section 121 includes a plurality of scan lines each having a predetermined reference scan line density. Based on a reference scan line group for forming a reference frame, the scan line group setting section 121 sets a group (“first scan line group”) having a lower scan line density than the reference scan line density and a group (“second scan line group”) having a higher scan line density than the reference scan line density.

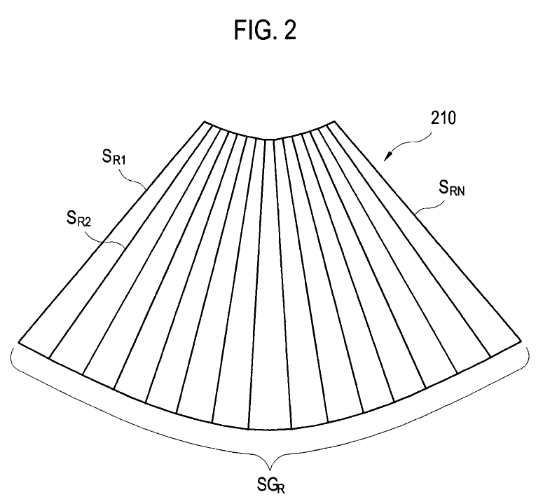

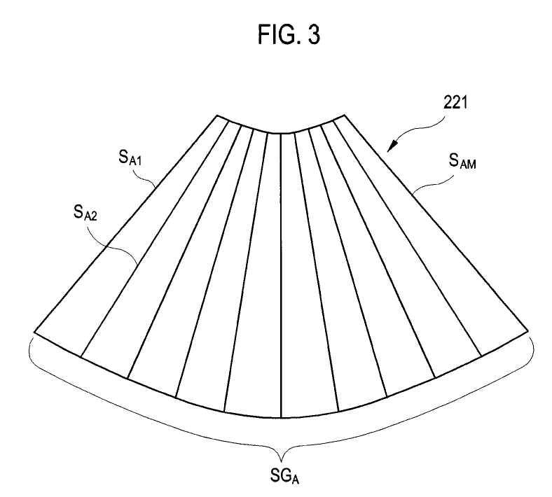

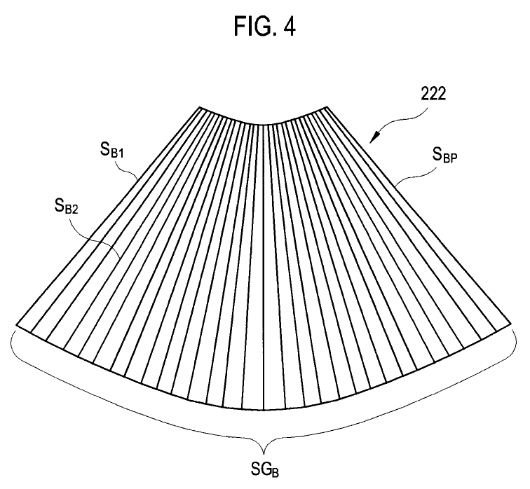

In accordance with one embodiment of the present invention, the scan line group setting section 121 sets the first scan line group (SG_{A}) and the second scan line group (SG_{B}) based on the reference scan line group (SG_{R}). As shown in FIG. 2, the reference scan line group (SG_{R}) includes a plurality of scan lines (S_{R1} to S_{RN}) having a predetermined reference scan line density. The first scan line group (SG_{A}) includes a plurality of scan lines (S_{A1} to S_{AN}) each having a lower scan line density than the reference scan line density as shown in FIG. 3. Further, the second scan line group (SG_{B}) includes a plurality of scan lines (S_{B1} to S_{BN}) each having a higher scan line density than the reference scan line density as shown in FIG. 4. The first scan line group (SG_{A}) and the second scan line group (SG_{B}) are used to form the first frame 221 and the second frame 222, respectively.

Although it is explained herein that the first and second scan line groups are set based on the reference scan line group, the present invention is certainly not limited thereto. It should be appreciated that at least two first scan line groups and at least two second scan line groups may be set based on the reference scan line group.

The controller 122 may be configured to perform control in such a manner that ultrasound signals are transmitted and received along the scan lines of the respective scan line groups at every frame change in order to form a plurality of frames. According to one embodiment of the present invention, the controller 122 may be configured to perform control to transmit and receive ultrasound signals along the scan lines (S_{A1} to S_{AN}) of the first scan line group (SG_{A}) and the scan lines (S_{B1} to S_{BN}) of the second scan line group (SG_{B}) in order to form the first frame 221 and the second frame 222, respectively. The controller 122 may control the formation of the frames of each scan line group, the storage of each frame and the spatial compound of each frame.

The beam former 130 delays and sums the ultrasound signals transmitted and received by a plurality of transducers along the scan lines of the respective scan line groups corresponding to the respective frames, thereby forming a plurality of frames. The operation of the beam former 130 is controlled by the controller 122. The frame forming unit 140 forms a frame corresponding to each scan line group based on the receive-focused signals, which are outputted from the beam former 130. The storage unit 150 stores in sequential manner frames of each scan line group, which is outputted from the frame forming unit 140. The compound image producing unit 160 extracts a plurality of frames from the storage unit 150 and forms a compound image by spatial compound of the extracted frames under the control of the controller 122.

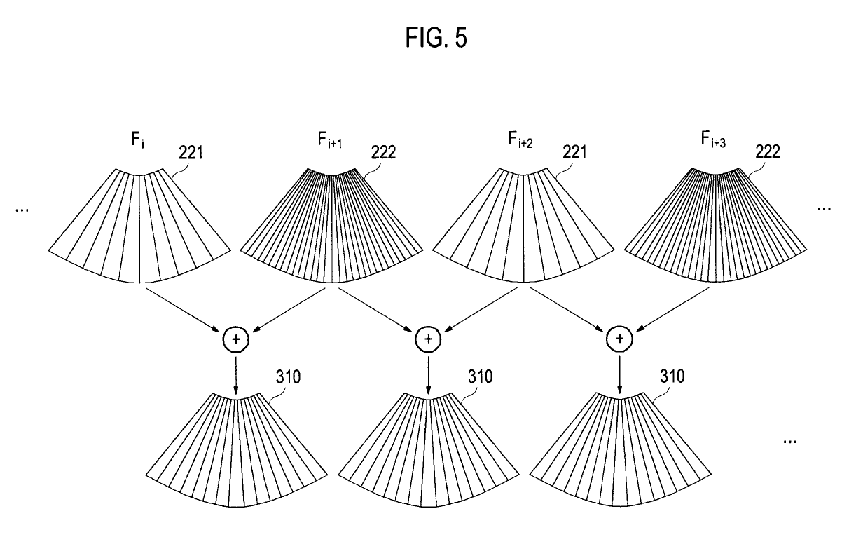

According to one embodiment of the present invention, the compound image producing unit 160 extracts the first and second frames (221 and 222) from the storage unit 150, as shown in FIG. 5. The compound image producing unit 160 forms the compound image 310 by spatial compound of the “i” th first frame (Fᵢ) and the “i+1” th second frame. Then, the compound image producing unit 160 forms the compound image 310 by spatial compound of the “i+1” th second frame (Fᵢ₊₁) and the “i+2” th first frame (Fᵢ₊₂). By doing so, the compound image producing unit 160 forms a plurality of compound images. In such a case, the compound image producing unit 160 may give different weights to the respective frames and compound the weighted frames. For example, the compound image producing unit 160 gives the first weight (e.g., 0.3) and the second weight (e.g., 0.7) to the first frame 221 and the second frame 222, respectively, and carries out spatial compound of the first and second frames. In such a case, the compound image is formed by spatial compound of two frames. However, it should be noted herein that the number of frames used for spatial compound is not limited to two. The compound image formed in the compound image producing unit 160 is displayed by the display 170.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An ultrasound system for forming an ultrasound image by using a plurality of frames, comprising:
a plurality of transducers for transmitting ultrasound signals to an object and receiving the ultrasound signals reflected from the object to form a reception signal;
a setting unit for setting a plurality of scan line groups each having a scan line density based on a predetermined reference scan line group including a plurality of scan lines each having a predetermined reference scan line density;
a controller for controlling the transmission and reception of the ultrasound signals so as to form frame data corresponding to the respective scan line groups at every frame change;
a frame forming unit for forming a plurality of frames corresponding to the respective scan line groups based on multiply formed frame data; and
a compound image forming unit for forming a compound image by spatial compound of the plurality of frames.

2. The ultrasound system of claim 1, wherein the setting unit includes:
a scan line group setting unit for setting a first scan line group including a plurality of scan lines each having a lower scan line density than the reference scan line density and a second scan line group including a plurality of scan lines each having a higher scan line density than the reference scan line density.

3. The ultrasound system of claim 2, wherein the controller controls the reception and transmission of the ultrasound signals to alternately obtain the frame data corresponding to the first and second scan line groups at every frame changes.

4. The ultrasound system of claim 1, wherein the compound image forming unit includes:
a weight supplying unit for providing different weights to the frames corresponding to the respective scan line groups; and
a spatial compounding unit for forming a compound image by spatial compound of the weighted frames.

5. The ultrasound system of claim 4, wherein the weight supplying unit provides the first and second weights to the frames corresponding to the first and second scan line groups, respectively, and wherein the first weight is less than the second weight.

6. The ultrasound system of claim 1, further comprising:
a storage unit for storing a plurality of frames.

7. A method of forming an ultrasound image by using a plurality of frames, comprising:
a) setting a plurality of scan line groups having a plurality of scan lines each having a scan line density based on a predetermined reference scan line group including a plurality of scan lines each having a predetermined scan line density;
b) transmitting and receiving ultrasound signals to and from an object along the scan lines each of the scan line groups to form frame data;
c) forming frames corresponding to the respective scan line groups based on multiply formed frame data; and
d) forming a compound image by spatial compound of the frames corresponding to the respective scan line groups.

8. The method of claim 7, wherein the step (a) includes:
setting a first scan line group including a plurality of scan lines each having a lower scan line density than the reference scan line density and a second scan line group including a plurality of scan lines each having a higher scan line density than the reference scan line density.

9. The method of claim 8, further comprising:
controlling the reception and transmission of the ultrasound signals to alternately obtain the frame data corresponding to the first and second scan line groups at every frame changes.

10. The method of claim 7, further comprising:
providing different weights to the frames corresponding to the respective scan line groups; and
forming a compound image by spatial compound of the weighted frames.

11. The method of claim 10, wherein the step of providing different weights provides the first and second weights to the frames corresponding to the first and second scan line groups, respectively.

12. The method of claim 11, wherein the first weight is less than the second weight.
